(19) United States
(12) Patent Application Publication
(10) Pub. No.: US 2007/0283057 A1
(43) Pub. Date: Dec. 6, 2007

(54) ELECTRONIC MODULE FOR PROGRAMMING CHIP CARDS COMPRISING CONTACTS

(75) Inventor: Daniel Brumfield, Cham (DE)

Correspondence Address: MICHAEL BEST & FRIEDRICH LLP, 100 E WISCONSIN AVENUE, Suite 3300, MILWAUKEE, WI, 53202, US

(73) Assignee: MUEHLBAUER AG, Roding (DE)

(21) Appl. No.: 11/734,735

(22) Filed: Apr. 12, 2007

Related U.S. Application Data
(63) Continuation of application No. PCT/EP05/08576, filed on Aug. 8, 2005.

(30) Foreign Application Priority Data
Oct. 12, 2004 (DE) 102004049671.4

(51) Int. Cl. G06F 13/12

(52) U.S. Cl. 710/62

(57) ABSTRACT

The invention relates to an electronic module for reading data on and/or writing data to at least one card-type carrier, in particular an electronic module of this type comprising a control unit for controlling at least one interface that can be connected to the card-type data carrier for receiving and/or sending the data. In one aspect, the electronic module according to the invention comprises at least one first interface which can be connected to the card-type data carrier for receiving and/or sending the data, and a control unit for controlling the first interface. The control unit is formed by an embedded PC which communicates with the first interface via a data bus.

### RELATED APPLICATIONS

This application is a continuation of international patent application number PCT/EP2005/008576, filed on Aug. 8, 2005, which claims priority to German patent application number 10 2004 049 671.4, filed on Oct. 12, 2004. The contents of both applications are hereby incorporated by reference.

### BACKGROUND OF THE INVENTION

1. Field of the Invention

The present invention generally relates to an electronic module for reading data on and/or writing data to at least one card-type data carrier, in particular an electronic module comprising a control unit for controlling at least one interface that can be connected to the card-type data carrier for receiving and/or sending the data.

2. Description of the Related Art

Due to numerous developments in various fields, card-type data carriers have gained increasing importance. In particular so-called smart cards, which comprise integrated circuits (chips), are used in the most varied fields of application, because they can store substantially more information than, for example, magnetic cards. In the field of credit and debit cards, smart cards are finding increasing use, because they facilitate a substantial increase in security for transactions carried out with the card. Additionally, ever more bonus programmes based on smart cards are used in the retail trade or by other companies and an increasing awareness with respect to the misuse of personal data with various online transactions is leading to additional demand for smart card systems in the PC environment. As so-called SIM cards (SIM=Subscriber Identity Module), this type of card-based data carrier has also become popular in the field of telecommunication terminal devices.

Furthermore, with chip cards one of the main differentiating features is whether the card is a type with contacts or without contacts. With the type comprising contacts the energy and information transfer takes place via a contact arrangement; examples of this are the currently employed telephone or money cards. In contrast to this, with the type of card without contacts, the energy and information transfer takes place by means of inductive or capacitive coupling or by means of radiation coupling.

With regard to the information and energy transfer, there are also chip cards which exhibit mixed forms here, e.g. the energy is transferred inductively, whereas the information transfer takes place by means of radiation energy. Chip cards can also be designed for both types of coupling—with and without contacts.

During the manufacture and programming of these types of chip card, data must be written to the chip card or a preliminary stage of it, for example a chip module, and read out again both for test purposes during the manufacturing process and also before shipment to the customer. Particularly during the manufacture of these types of chip card and chip module a problem occurs in that the communication protocol used for the data interchange with the chip module can often change depending on the type of card.

For example, it must be possible to make different settings of signals, such as different clock frequencies, different voltage values and types of protocol.

Normally data is written to and read out from the integrated circuit of a smart card by means of a so-called card reader. Here, with some of the known solutions, the clock frequency of the signal transfer can be changed according to the requirements of the particular chip card. From EP 0 889 429 B1, for example, it is known that the system clock supplied by a microcomputer can be appropriately adapted by means of a digitally programmable divider. Furthermore, it is known that a number of oscillators can be provided in the card reader which are activated appropriate to the required clock frequency (refer to, for example, the US patent application US 2003/0024984 A1). From the U.S. Pat. No. 6,138,029 a smart card reader is also known in which first and second oscillators are selected by means of a switch in order to provide the system clock.

Furthermore, known smart card readers are often connected to a higher level computer by means of an RS232/RS485 interface or a USB interface. Dedicated programs are used here in each case for the different communication protocols.

There is therefore the requirement of providing a universally applicable electronic module with which data communication can be carried out with a card-type data carrier in a particularly effective, flexible and fast manner.

### SUMMARY OF THE INVENTION

An electronic module is provided for reading out and/or writing data on at least one card-type data carrier, with at least one first interface, which can be connected to the card-type data carrier for receiving and/or sending the data, and a control unit for controlling the first interface, wherein the control unit is formed by an embedded PC, which communicates with the first interface via a data bus.

Furthermore, a method is provided for reading out and/or writing data on at least one card-type data carrier with the following steps: connecting the card-type data carrier to a first interface; selecting an interface unit of the first interface in accordance with a predetermined communication protocol associated with the card-type data carrier by an embedded PC; controlling the selected interface unit by the embedded PC via a data bus for sending and/or receiving the data.

### BRIEF DESCRIPTION OF THE DRAWINGS

For better understanding of the invention it is explained in more detail using embodiments illustrated in the following figures. Here, the same parts are given the same reference symbols and the same component designations in the various described embodiments, wherein the disclosures contained in the complete description can be transferred logically to the same parts with the same reference symbols or component designations. Furthermore, some characteristics or characteristic combinations from the illustrated and described different embodiments can also represent independent, inventive solutions or solutions according to the invention. The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention which is illustrated in the accompanying drawings, wherein:

FIG. 1 A block diagram depicting the principle of a chip card system according to the invention.

FIG. 2 A simplified block diagram of an embedded PC.

FIG. 3 A first embodiment of an electronic module according to the invention.

FIG. 4 An extract of the electronic module according to FIG. 3.

FIG. 5 A simplified block diagram showing the principle of an FPGA.

### DETAILED DESCRIPTION OF THE INVENTION

The illustrated embodiments of the present invention will be described with reference to the figure drawings wherein like elements and structures are indicated by like reference numbers.

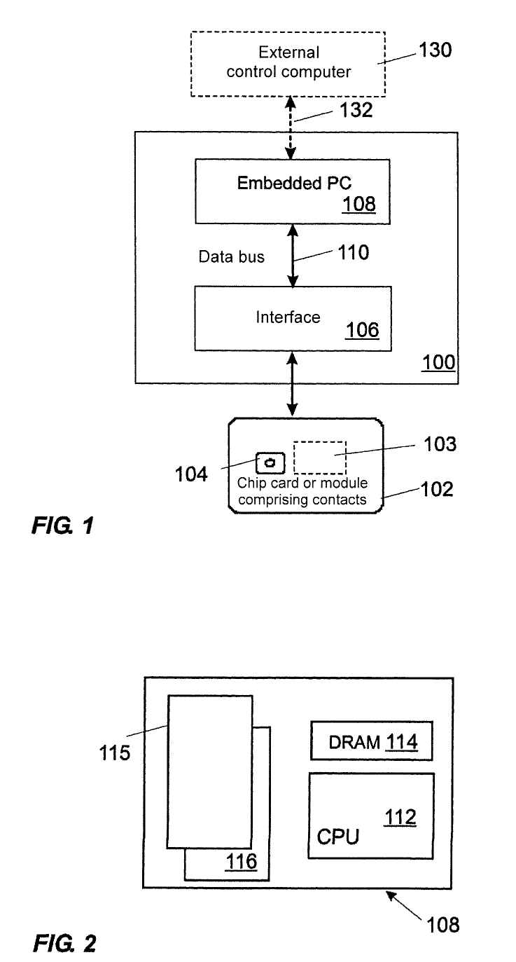

The basic principle of the invention will now be explained in more detail with reference to FIG. 1. The electronic module 100 according to the invention is used for communication with a chip card 102, which comprises at least one integrated circuit 103, the chip, for the storage and possible processing of data. The chip card may be a so-called smart card or a media card in cheque-card format, as well as a so-called SIM card with a smaller size.

Furthermore, the invention can be used in a very advantageous manner for test devices with which communication is to take place, not with the finished, assembled chip card, but rather with the integrated circuit 103 in an incomplete preliminary stage of assembly, for example a chip module present on an endless belt.

Furthermore, the embodiments presented in the following are primarily concerned with communication with a chip card having contacts. Of course, the embodiments according to the invention can also be used with forms of wireless communication.

As shown in FIG. 1, in the case of a chip card possessing electrical contacts 104, the chip card 102 is connected to a first interface 106. The contact assignment and the associated signals can, for example, be designed as specified in ISO 7816. However, it is clear that the principles according to the invention can also be used for the case of chip cards having no contacts.

The module 100, which for example is installed in a device for the testing of chip cards in chip card production or which can also be used for the programming of chip cards before shipment to the end-user, communicates with the chip card 102 via the first interface 106. According to the invention the electronic module 100 comprises an embedded PC 108 which is connected to the first interface via a data bus 110. Since the embedded PC is fully bus-compatible and has a very high functionality, the communication protocols of the first interface can be handled very flexibly.

As the embedded PC module 108, for example, a plug-in ETX card can be considered. Here, the abbreviation ETX stands for “Embedded Technology extended” and designates a form factor for the development of so-called embedded systems in which cables and connectors have largely been dispensed with to simplify the design. The ETX-PC is characterised by relatively small dimensions (114 mm×95 mm, maximum thickness 12 mm). However, any other card formats can also be used. FIG. 2 shows schematically a type of arrangement in which the embedded PC 108 normally comprises a CPU module 112, various memories 114, 116 as well as different interfaces, such as the PCI bus interface and the Ethernet interface 115. For trouble-free upgrading one or more of the memories 114, 116 can be of plug-in design with the format SO-DIMM.

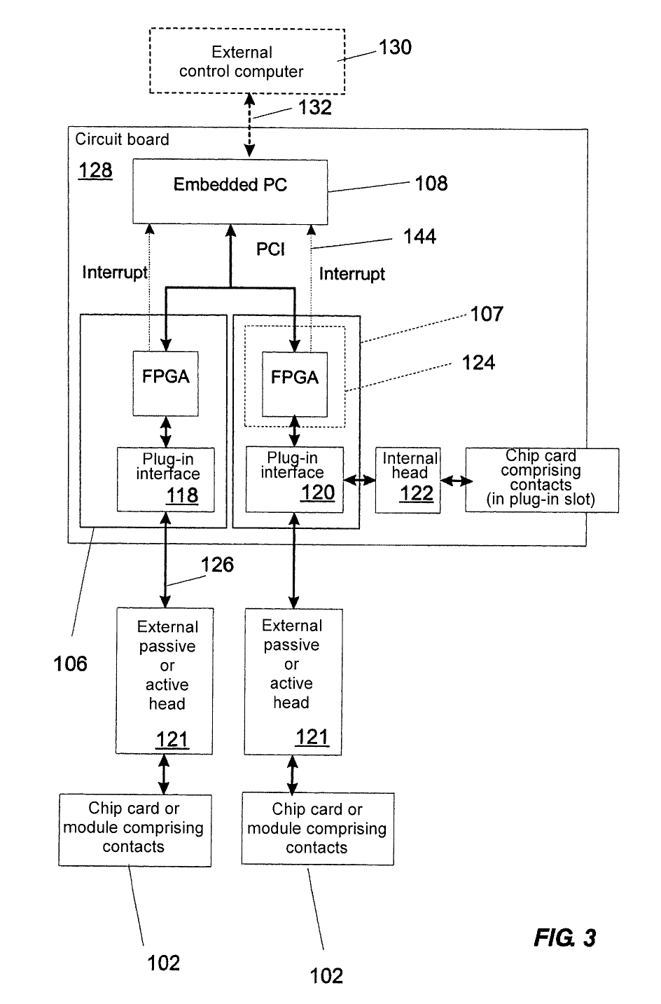

FIG. 3 shows in a heavily schematised method of illustration a block diagram of an electronic module 100 according to the invention and according to a possible embodiment, which could be advantageous for programming the cards in the manufacture of chip cards with a high throughput rate.

According to the embodiment illustrated in FIG. 3, the electronic module 100 according to the invention comprises a total of two first interfaces 106, 107, each of which is connected via a plug-in interface circuit 118, 120 to contacting heads 122, 121 for electrically contacting the chip cards 102. In this arrangement the contacting head 122 is an internal head, i.e. it is mounted directly on the circuit board of the module 100 and is accessible from outside for the chip card 102 via a plug-in slot. As explained more precisely in the following, this internal head 122 is needed for the communication with a card containing the access rights or an encryption key.

Each of the interfaces 106 contains a Field Programmable Gate Array (FPGA) 124 which includes the main interface components.

Each FPGA 124 has its own PCI bus interface and in each case controls an independent plug-in interface circuit 118, 120. The interface circuits 118 then communicate with the integrated circuit on the chip card 102 or on the uncased module via the contacting head. The contacting head 121 is either a so-called active or passive head, i.e. it is used either just for the electrical contacting of the chip card or also handles signal conditioning. Active heads which include signal conditioning have the advantage that the conditioned signals can be passed to the electronic module more easily and with fewer disturbances. This is particularly advantageous when the feeder cable 126 is relatively long.

In an advantageous embodiment the interface circuit 118, 120 can be plugged onto the circuit board 128 of the electronic module in a modular manner. Adaptation to different external heads 121 is possible without problem in this way. According to this embodiment the two first interfaces 106, 107 differ in that the interface 107 can also control an internal card reader 122. Using this device, it is possible, for example, to interrogate access rights or encryption keys without the encoded elements having to be transferred between a data base and the circuit board 128. The decoding can take place directly on the circuit board 128 itself, thus relieving a higher level control PC if present. The actual control occurs via the embedded PC 108, which is connected to the two interfaces 106 and 107 via the PCI bus 110.

Optionally, the embedded PC can be in contact via an Ethernet connection 132 with a higher level computer unit in which, for example, data bases are also localised. The higher level controller 130 can however also be waived, if for example only simple testing tasks are to be carried out for which the functionality of the embedded PC 108 is sufficient. Additionally, an interrupt signal can be transferred from the FPGA 124 to the embedded PC 108 via the PCI bus 110.

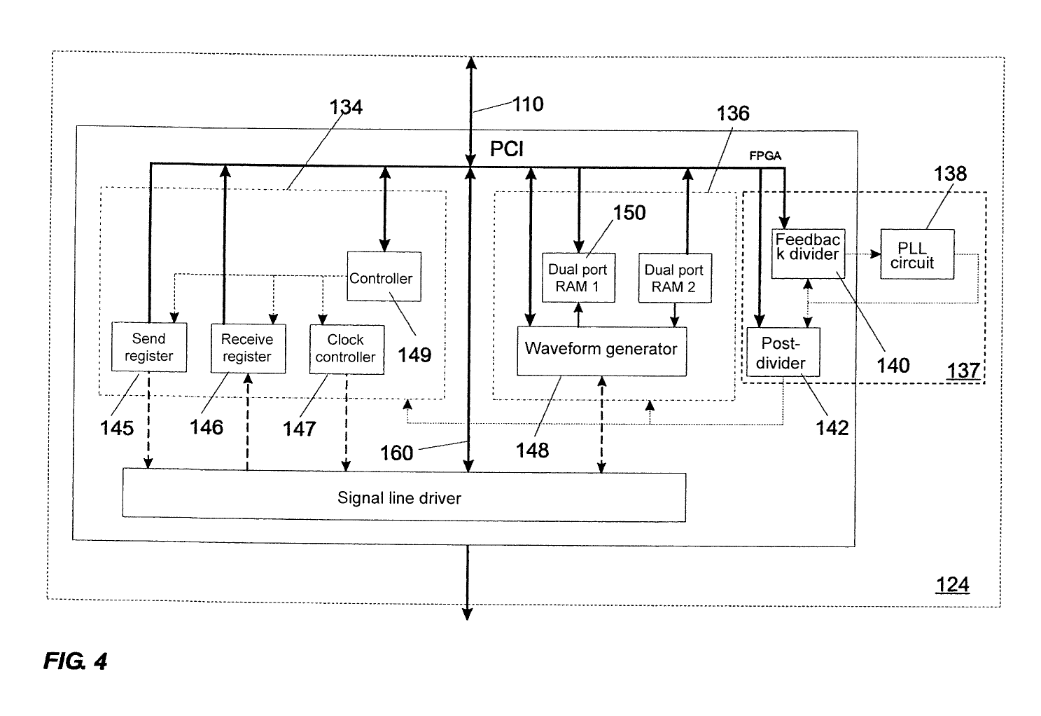

A possible advantageous embodiment of the FPGA 124 is described in the following with reference to FIG. 4. As can be seen in FIG. 4, two different interface units 134, 136 are contained in each of these FPGAs 124. One of the two units 134 or 136 can be selected via the PCI bus 110 appropriate to the required communication protocol of the chip card to be programmed. Here, this selection can occur automatically based on an interrogation of the chip card or via a preset adjustment made by a user. In addition to the communication via the interface units 134, 136 the contact pins can also be accessed directly via the PCI bus 110, as is symbolised by the double arrow 160 between the PCI bus 110 and the signal line drivers.

With both interface units 134, 136 the time or clock control occurs via a phased-locking control loop, a so-called phase locked loop (PLL) circuit 138. In order to obtain an adjustable system clock in a simple manner with the aid of the PLL circuit 138, the so-called feedback divider, i.e. the feedback divider arranged in the feedback path of the phase-locking control loop, is realised in the FPGA 124.

The divider ratio of the divider 140 is defined by a register which can be written to via the PCI bus 110. The output frequency supplied by the PLL circuit 138 can then alternatively be divided again by a post-divider 142. The dividing ratio of the post-divider is set according to the invention similarly by means of the PCI bus 110. Here, the selection of this post-division occurs synchronously with the slowest frequency. All the circuits of the FPGA interfaces 124 can then be operated with the frequency which is thus generated. This facilitates different timing settings depending on the requirements of the particular chip card without the frequency of the processor on the embedded PC having to be changed. Additionally, the required frequency can be selected without glitches by a simple memory access and the frequency can be defined precisely over a large range with high resolution.

The functional principle of the interface units 134, 136 will now be explained in detail with reference to FIG. 4. The first interface unit 134 is used for communication with the chip card in a so-called processor mode. The interface unit 134 consists of a serial interface with automatic, byte-wise transfer for asynchronous serial protocols, wherein the convention, that is for example the definition, of whether a high or low potential is interpreted as a logical one, the bit direction (MSB or LSB first), parity, number and level of the start and stop bits, the number of data bits, etc. is managed by the higher level software. The software which can be saved in the embedded PC 108, prepares the data and then sends it byte-wise to the interface 106. The interface 106 or 107 sends the data independently to the chip card 102 and confirms the error-free transfer. In addition, the interface unit 134 also monitors the conformance to minimum waiting times. After the conclusion of the transfer and/or the minimum waiting times, the embedded PC 108 is informed by an interrupt signal 144. An interface controller 149 is provided for all tasks directly controlled by the interface unit.

The interface unit also independently receives the data sent from the chip card and informs the embedded PC 108 that received data can be fetched. These are saved in a receive register 146. The clock signal is similarly controlled from the interface unit 134 by means of a clock controller 147. Here, the clock signal is started, selected or stopped without disturbing glitches arising. Additionally, a defined stop state is possible.

The second interface unit 136 is used for communication with the chip card in a so-called memory mode. The second interface unit comprises a semi-automatic waveform generator 148 for synchronous or custom protocols. Here, prepared signal sequences are filled into a dual-port random access memory (RAM) 150 by means of a burst access via the PCI bus 110 and the waveform generator 148 is then started. The waveform generator 148 processes the signal sequence in that the individual data records are fetched from the dual-port RAM 150 and executed. Each data record consists of a signal status to be output, a waiting time and various flags. First the signal statuses are output and the signal lines sampled in dependence of the flags. Then the waiting period is allowed to pass. This procedure is repeated until the end flag set in the data record is reached. Then the waveform generator 148 terminates the output and informs the embedded PC 108 via an interrupt signal 144. The samplings arising during the sequence processing are saved in a second dual-port RAM 152. These samplings are then fetched by the software via a burst memory access and can be evaluated.

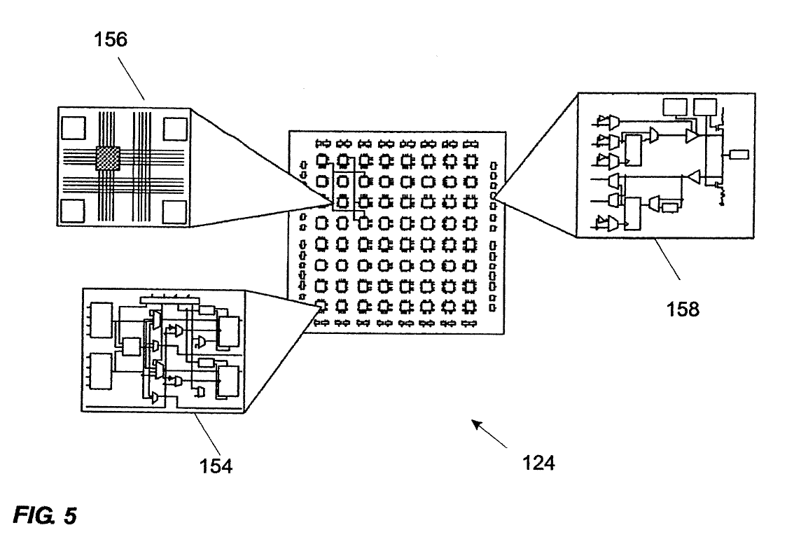

The typical structure of the FPGA 124 is shown schematically in FIG. 5. Generally, an FPGA can be regarded as a freely configurable pool of elementary logic modules. The configurable logic blocks 154 and the connections 156 between these logic blocks can be freely programmed by a user. It is therefore possible on one FPGA to realise a large number of digital circuits of gates and counters, FIFOs, memories and controllers. The link to the outside world takes place via the input/output blocks 158 which are also schematically illustrated in FIG. 5. Due to their flexibility, FPGAs can above all execute various tasks and can be adapted to new requirements in a particularly simple manner.

The solution according to the present invention is based on the idea of connecting a full so-called embedded PC to an appropriately configurable interface via a standard data bus. Here, an embedded PC designates a computer system which is designed as an integral (“embedded”) constituent part of a technical system and is generally realised as a plug-in module.

Embedded PCs, which are widespread in industrial applications, have the advantage that they can be purchased as ready-made hardware components with extensive functional features and can be equipped by the user with user-specific software. In this respect the programming can be carried out with the aid of commonly available higher level programming languages and familiarisation in proprietary systems is then not required.

The use of an embedded PC in the electronic module according to the invention opens up the possibility with the interface to the chip card of communicating over a data bus and of communicating with an optional higher level computer, which for example can contain extensive data bases or provide access to the Internet by means of a network-compatible interface, such as an Ethernet interface. Simultaneously, the use of an embedded PC also offers the advantage that comparatively complex coding tasks can be carried out also without the use of an additional computer, but rather exclusively under the control of the module according to the invention.

Through the use of the embedded PC it is ensured that with an optional higher level control computer, no modifications have to be made and the module according to the invention can be controlled as a standard peripheral device.

Due to the use of a standard data bus, for example a so-called Peripheral Component Interconnect (PCI) bus, all settings and data transfers can be carried out by simple and fast memory accesses. Critical time controls can be carried out by digital circuits in the interface and the software can be thus significantly relieved in an advantageous manner.

By definition embedded PCs are modular components which can be interchanged without effort. Therefore it is possible to modify the performance capability and also the available memory size of the required memory elements through simple replacement of the embedded board or memory module, which for example are realised as standard SO-DIMM components. The performance capability of the module can in this way be increased by a simple plug & play method.

With the electronic module according to the present invention it is possible to carry out the data communication with chip cards which support a wide spectrum of communication protocols. This is in particular of significance if cards are to be checked or programmed for the most varied applications with less cost-intensive equipment.

According to a preferred embodiment, the interface to the chip card is subdivided into two interface units of which each comprises the constituent parts needed for a different type of protocol. Of course, the invention is not restricted to these two interface units and more than two units can be provided.

According to an advantageous embodiment the first interface unit is formed by a serial interface with an automatic byte-wise data transfer for asynchronous serial protocols. The second interface unit comprises a semi-automatic waveform generator for synchronous or custom protocols. Both interface units are directly addressed via the data bus. The embedded PC selects the interface unit required for a particular chip card and then carries out the communication via this interface unit. This selection can here either take place based on an interrogation of the chip card or by a preset option selected by the user.

According to an advantageous further development the first interface comprises a so-called Field Programmable Gate Array (FPGA) on which the required functions of the individual interface units can be realised in a particularly efficient manner. In this respect FPGAs generally offer the advantage that the development effort is low and an adaptation to changed requirements can be carried out quickly and easily. In particular with an FPGA the programmable memory elements (PROM) can be replaced without problem and thus facilitate an easy hardware upgrade.

According to a further advantageous embodiment, two first interfaces are provided, of which both offer the possibility of communicating with a chip card via different interface units. In this manner the electronic module according to the invention can program or read out more than one chip card simultaneously. Here, the use of an embedded PC according to the invention and a data bus for the communication with the interfaces really comes to bear, because genuine parallel processing of chip cards is possible.

According to a further advantageous embodiment the first interface comprises a plug-in interface circuit for the connection of a separate contacting head. This type of contacting head provides the electrical contact to the contacts on a chip card accessible from the outside. In this respect contacting heads can also be controlled which are suitable for contacting chip modules that are not yet completely embedded in a chip card, for example for test purposes. Alternatively, this type of contacting head can also provide the contactless connection to a chip card.

According to a further advantageous embodiment, at least one contacting head, a contacting head designated in the following as internal head, is directly arranged on the electronic module according to the invention. This contacting head, which is accessible to a chip card for example by means of a plug-in slot, offers the advantage that access rights or encryption keys, which can be stored on a further chip card of this nature, can be interrogated without encoded elements having to be transferred, for example between an external data base and the electronic module. The decoding can then take place directly on the electronic module itself and, where present, a higher level control PC is relieved of tasks of this nature.

A significant difficulty in the adaptation of a card reader or writing device to a certain type of chip card is that sometimes different clock frequencies are needed. According to an advantageous embodiment of the invention, the required system clock is set by means of a phase-locking control loop (a so-called Phase Locked Loop, PLL), which comprises a feedback divider arranged in the feedback path of the phase-locking control loop.

According to the invention, the divider ratio of this feedback divider can be adjusted to requirements by means of a command sent via the data bus. If the feedback divider of the PLL circuit is arranged in an FPGA which also realises the interface, the divider ratio of the divider can be defined by a register that can be written to via the data bus. This facilitates different timing settings without the clock frequency of the processor itself having to be changed. In addition, in this way the frequency can be selected without glitches via a simple memory access. Finally, this arrangement facilitates an accurate frequency behaviour over a wide frequency range and with a high resolution.

To increase the flexibility of adjustment of the clock frequency still further, the output frequency of the PLL circuit can again be subdivided by a further divider which can also be addressed via the data bus. Here, the selection of this post-division should occur synchronously with the slowest frequency. All the circuits of the first interface are then operated with the frequency which is thus generated.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

In addition, those areas in which it is believed that those ordinary skilled in the art are familiar have not been described herein in order not to unnecessarily obscure the invention described herein.

Accordingly, it is to be understood that the invention is not to be limited by the specific illustrated embodiments but only by the scope of the appended claims.

What is claimed is:

1. Electronic module for reading out and/or writing data on at least one card-type data carrier, comprising:
at least one first interface, which can be connected to the card-type data carrier for receiving and/or sending the data, and
a control unit for controlling the first interface,
wherein the control unit is formed by an embedded PC, which communicates with the first interface via a data bus.

2. Electronic module according to claim 1, wherein the first interface comprises a first interface unit, which is formed such that it interchanges data with the card-type data carrier by using a first communication protocol, and at least a second interface unit, which is formed such that it interchanges data with the card-type data carrier by using at least one second communication protocol, and wherein the control unit is formed such that it selects one of the interface units for receiving and/or sending the data in dependence of a type of protocol assigned to the card-type data carrier.

3. Electronic module according to claim 2, wherein the first communication protocol is an asynchronous protocol and the at least one second protocol is a synchronous protocol.

4. Electronic module according to claim 3, wherein the first interface unit comprises a send register for saving the data to be transferred to the card-type data carrier, a receive register for saving the data received from the card-type data carrier, a clock control unit for controlling a transfer cycle and an interface controller for controlling the asynchronous data transfer.

5. Electronic module according to claim 3, wherein the second interface unit comprises a waveform generator for generating a send signal, which is connected to the data bus via at least one memory with freely selectable access.

6. Electronic module according to claim 1, wherein the at least one first interface comprises a field programmable gate array.

7. Electronic module according to claim 1, wherein the at least one first interface also comprises at least one contacting head for the electrical contacting of electrical contacts of the card-type data carrier.

8. Electronic module according to claim 7, wherein at least one of the contacting heads is constructed as a separate external contacting head module.

9. Electronic module according to claim 7, wherein at least one of the contacting heads is integrated constructively in the electronic module.

10. Electronic module according to claim 7, wherein the at least one first interface comprises a plug-in interface circuit for connecting the contacting head.

11. Electronic module according to claim 7, wherein the contacting head is set up to carry out signal preparation of the data received from the card-type data carrier.

12. Electronic module according to claim 7, wherein the contacting head is a passive contacting head.

13. Electronic module according to claim 1, wherein the data bus is a peripheral component interconnect bus.

14. Electronic module according to claim 1, wherein the electronic module comprises a clock generation unit, which produces an adjustable clock signal in dependence of control signals from the control unit.

15. Electronic module according to claim 14, wherein the clock generation unit comprises a phase-locking control loop with a feedback divider, which is arranged in a feedback path of the phase-locking control loop, and wherein the divider ratio of the feedback divider can be adjusted in response to the control signal.

16. Electronic module according to claim 15, wherein the feedback divider is constructed as a field programmable gate array.

17. Electronic module according to claim 15, wherein the clock generation unit comprises a second divider, which receives the output signal of the phase-locking control loop to produce the clock signal and the divider ratio of which can be set by the control unit.

18. Electronic module according to claim 17, wherein the second divider is constructed as a field programmable gate array.

19. Electronic module according to claim 1, wherein at least one second interface is provided for communication with a higher level control unit.

20. Electronic module according to claim 19, wherein the second interface is an Ethernet interface.

21. Electronic system with an electronic module for reading out and/or writing data on at least one card-type data carrier, comprising:
at least one first interface, which can be connected to the card-type data carrier for receiving and/or sending the data, and
a control unit for controlling the first interface,
wherein the control unit is formed by an embedded PC, which communicates with the first interface via a data bus, said system further comprising at least one card-type data carrier.

22. Electronic system of claim 21, wherein the data carrier is formed by a SIM card, a smart card, a flash card or a multimedia card.

23. Electronic system of claim 21, wherein the data carrier is formed by a chip module which is not yet fully assembled.

24. Method for reading out and/or writing data on at least one card-type data carrier with the following steps:
connecting the card-type data carrier to a first interface,
selecting an interface unit of the first interface in accordance with a predetermined communication protocol associated with the card-type data carrier by an embedded PC,
controlling the selected interface unit by the embedded PC via a data bus for sending and/or receiving the data.

25. Method according to claim 24, wherein for the case that an asynchronous communication protocol is associated with the card-type data carrier, a first interface unit is selected and the control of the selected interface unit comprises:
preparation of data to be sent by the embedded PC and byte-wise transfer to a send register of the first interface unit via the data bus.

26. Method according to claim 25, wherein the data from the send register are sent under control of an interface controller to the card-type data carrier and after the termination of the transfer an interrupt signal is transferred to the embedded PC from the interface controller.

27. Method according to claim 26, wherein the interface controller furthermore monitors conformance to the minimum waiting times.

28. Method according to claim 24, wherein data, which are sent from the card-type data carrier, are saved in a receive register of the first interface unit and the interface controller informs the embedded PC.

29. Method according to claim 24, wherein for the case that a synchronous communication protocol is associated with the card-type data carrier, a second interface unit is selected and the control of the selected interface unit comprises:
preparation of at least one signal sequence to be sent by the embedded PC and saving of the signal sequence in a first dual-port RAM of the second interface unit with a burst access via the data bus,
starting of a waveform generator of the second interface unit and transfer of the signal sequence to the card-type data carrier.

30. Method according to claim 29, wherein the at least one signal sequence comprises a signal status to be output, a waiting period and at least one flag.

31. Method according to claim 30, wherein the sampled signals are saved in a second dual-port RAM and read out via a burst memory access from the embedded PC.
